(19) United States
(12) Patent Application Publication
(10) Pub. No.: US 2025/0033445 A1
(43) Pub. Date: Jan. 30, 2025

(54) ROLLER BLIND SYSTEM

(71) Applicant: Rivian IP Holdings, LLC, Irvine, CA (US)

(72) Inventors: Philipp WOLF, Dana Point, CA (US); Nicholas MALACHOWSKI, Aliso Viejo, CA (US); Barry LETT, Woking (GB); James DOWLE, Laguna Beach, CA (US); Raghav JASWAL, Coventry (GB); Tom BERNATH, Huntington Woods, MI (US); Marcus MERIDETH, Irvine, CA (US)

(21) Appl. No.: 18/359,808

(22) Filed: Jul. 26, 2023

(51) Int. Cl. B60J 7/00

(52) U.S. Cl. CPC B60J 7/0015

(57) ABSTRACT

A roller blind can be provided for a roof system of a vehicle. A shade (e.g., cloth) of the roller blind can be retracted into a coil with bow springs fully extended in a straight configuration at their maximum width. When deployed, the ends of the bow springs are urged towards each other to form a narrower width and a curved shape. This allows the shade to conform to the curved shape of the overlying roof system (e.g., glass) and provide more headroom within the cabin.

### INTRODUCTION

A vehicle can include a roof system that includes features to allow light and/or air to enter and/or exit the cabin of the vehicle. Such roof systems can include, for example, a sunroof, a moonroof, and/or a window.

Aspects of the subject technology can help to improve roof systems by providing a roller blind system with controlled deployment and retraction that also provides space efficiency enhancements in both the deployed and retracted configurations.

### SUMMARY

The present description relates generally to roof systems for vehicles that include features that allow light and/or air to enter and/or exit the cabin of the vehicle. A roller blind system of the vehicle can be provided with the roof system to controllably cover or expose portions of the roof system so that the passengers of the vehicle can determine whether to receive the effects of the light and/or air as desired. Such a system can include a shade that transitions between a retractable configuration and a deployed configuration. The shade (e.g., cloth) of the roller blind can be retracted into a coil with bow springs fully extended in a straight configuration at their maximum width. This can allow the shade to be stored in a highly compact configuration. When deployed, the ends of the bow springs are urged towards each other to form a narrower width and a curved shape. This can allow the shade to conform to the curved shape of the overlying roof system (e.g., glass) and provide more headroom within the cabin than would be provided with a flat shade.

In accordance with one or more aspects of the disclosure, a shade for a roller blind system can include a flexible sheet; multiple bow springs distributed along a length of the flexible sheet, each of the bow springs extending transversely to the length of the flexible sheet; and multiple pads, each of the pads being positioned on a side of a corresponding one of the bow springs that is opposite the flexible sheet.

According to some aspects, guide cables can each extend along one of opposing ends of the flexible sheet and adjacent to a corresponding end of each of the bow springs. The shade can be configured to transition between: a coiled configuration about a roller drum with each of the bow springs in a straight configuration; and a deployed configuration within a rail assembly with each of the bow springs in a curved configuration. In the deployed configuration, the multiple pads can define a maximum height of the shade. In the coiled configuration, opposing edges of the shade, defining a width of the shade, can be a first distance apart from each other; and in the deployed configuration, the opposing edges of the shade can be a second distance, less than the first distance, apart from each other. Guide cables can each be coupled to a corresponding one of the opposing edges of the shade. Drive cables can be coupled to opposing sides of an endmost one of the bow springs, portions of the drive cables extending in parallel with portions of the guide cables. The flexible sheet can include a cloth material. Each of the multiple pads can include a fabric material.

In accordance with one or more aspects of the disclosure, a rail assembly for a roller blind system can include a pair of rails each configured to receive a corresponding one of opposing edges of a shade, each of the rails defining a channel having a first channel section and a second channel section, wherein the first channel sections are separated from each other by a first distance and define first openings directed towards each other, and wherein the second channel sections are separated from each other by a second distance, less than the first distance, and define second openings each directed above the other of the second channel sections.

According to some aspects, the first channel sections can extend in parallel with each other, and the second channel sections can be transverse to each other. Each of the channels can define a guide section continuous with the first channel section and the second channel section, the guide section can have a cross-sectional dimension that is greater than cross-sectional dimensions of the first openings and the second openings. Each of the channels can define a drive section for receiving a drive cable, the drive section being continuous with the first channel section and the second channel section of the corresponding channel. The rails can define a first width at the first channel sections and a second width at the second channel sections, the second width being smaller than the first width.

In accordance with one or more aspects of the disclosure, a roller blind system can include a shade comprising a flexible sheet and bow springs; a roller drum; and a rail assembly configured to receive opposing edges of the shade, wherein the shade is configured to transition between: a coiled configuration about the roller drum with each of the bow springs in a straight configuration; and a deployed configuration within the rail assembly with each of the bow springs in a curved configuration.

According to some aspects, in the coiled configuration, the opposing edges of the shade can be a first distance apart from each other; and in the deployed configuration, the opposing edges of the shade can be a second distance, less than the first distance, apart from each other. A drive unit can move drive cables coupled to the shade and extending through corresponding channels of the rail assembly. The drive cables can be further coupled to gears of the roller drum, wherein movement of the drive cables is configured to rotate the roller drum. The drive cables can be coupled to opposing sides of an endmost one of the bow springs of the shade. Each of the drive cables can form a closed loop.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle in accordance with one or more implementations.

FIG. 2 illustrates a perspective view of an interior side of a roof with a shade in a coiled configuration in accordance with one or more implementations.

FIG. 3 illustrates a perspective view of the interior side of the roof of FIG. 2 with the shade in a deployed configuration in accordance with one or more implementations.

FIG. 4 illustrates a top view of a roller shade system in accordance with one or more implementations.

FIG. 5 illustrates a perspective view of a portion of a roller shade system in accordance with one or more implementations.

FIG. 6 illustrates a top view of a roller shade system in accordance with one or more implementations.

FIG. 7 illustrates a perspective view of a roller shade system with a shade in a deployed configuration in accordance with one or more implementations.

FIG. 8 illustrates a perspective sectional view of a first section a rail in accordance with one or more implementations.

FIG. 9 illustrates a perspective sectional view of a second section a rail in accordance with one or more implementations.

FIG. 10 illustrates a perspective sectional view of a roller shade system with the first section the rail of FIG. 8 in accordance with one or more implementations.

FIG. 11 illustrates a perspective sectional view of a roller shade system with the second section the rail of FIG. 9 in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In many vehicles, roof systems can include features that allow light and/or air to enter and/or exit the cabin of the vehicle. It can be desirable to provide a system that controllably covers or exposes such a roof system so that the passengers of the vehicle can determine whether to receive the effects of the light and/or air as desired. Such a system can include a shade that transitions between a retractable configuration and a deployed configuration. It can further be desirable to store the shade in a highly compact configuration when retracted and deploy the shade in a shape that maximizes space (e.g., headroom) within the cabin of the vehicle.

Implementations of the subject technology described herein provide a roller blind for a roof system. The shade (e.g., cloth) of the roller blind system can be retracted into a coil with bow springs fully extended in a straight configuration at their maximum width. As described herein, aspects of the subject technology can allow the shade to be stored in a highly compact configuration. When deployed, the ends of the bow springs are urged towards each other to form a narrower width and a curved shape. As described herein, aspects of the subject technology can allow the shade to conform to the curved shape of the overlying roof system (e.g., glass) and provide more headroom within the cabin than would be provided with a flat shade.

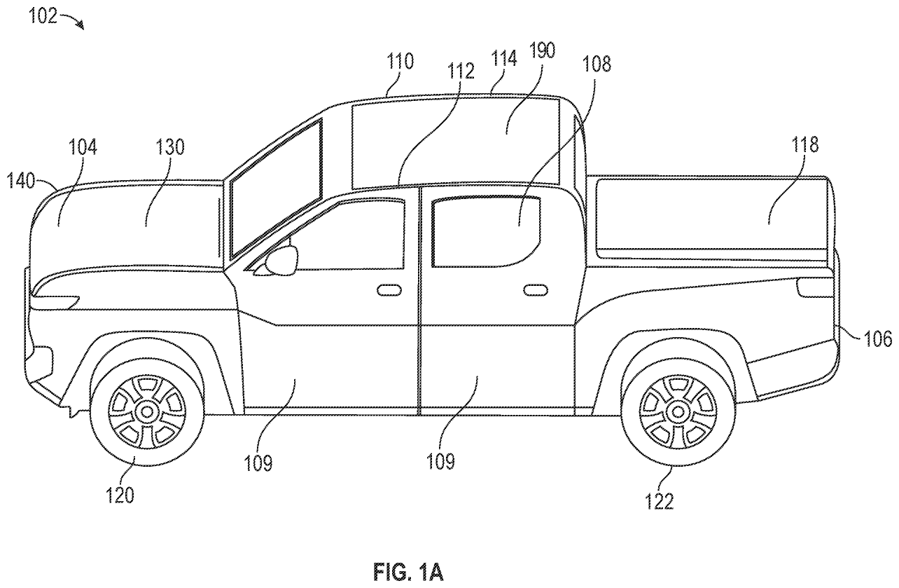

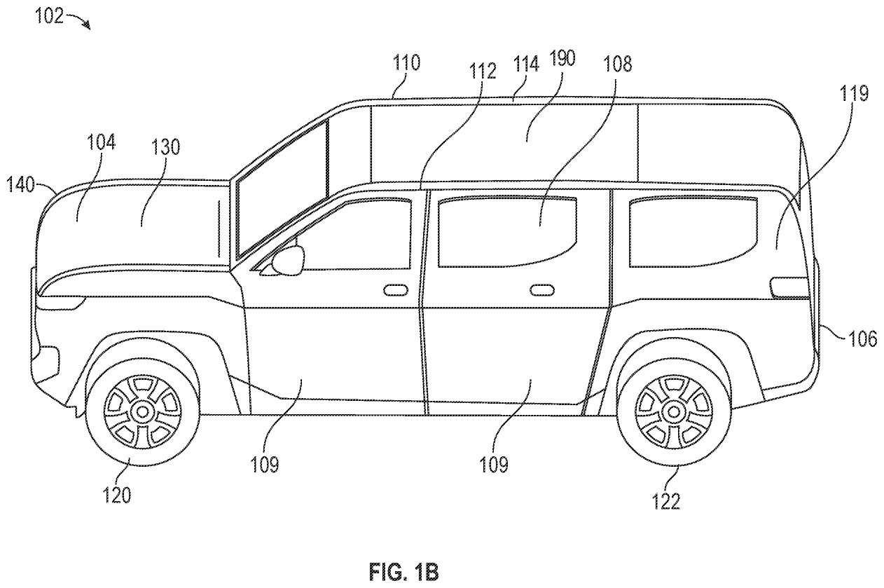

FIG. 1A is a diagram illustrating an example implementation of an apparatus as described herein. In the example of FIG. 1A, an apparatus is implemented as a moveable apparatus, such as a vehicle 102. In one or more implementations, the vehicle 102 may be an electric vehicle having one or more electric motors that drive the wheels of the vehicle. In one or more implementations, the vehicle 102 may also, or alternatively, include one or more chemically-powered engines, such as a gas-powered engine of a fuel cell powered motor. In various implementations, the vehicle 102 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

As shown, the vehicle 102 may have a front portion 104 and a rear portion 106. A cabin 108 may be located between the front portion 104 and the rear portion 106 of the vehicle 102. The cabin 108 may include entry doors 109. As illustrated, the vehicle 102 has a right side 110 and a left side 112.

Vehicle 102 may have one or more cargo spaces, such as a cargo bed or truck bed 118 (also referred to herein as a “trunk”) and/or a front cargo space 130 (also referred to herein as a front trunk or a “frunk”). Cargo bed 118 is typically located at or near the rear portion 106 of the vehicle. Vehicle 102 may have one or more front wheels 120 and one or more rear wheels 122. Vehicle 102 of FIG. 1A may be a unibody truck, which may have a storage bed. One or more portions of a body 140 of the vehicle 102 may be constructed of steel alloy and/or aluminum alloy or other suitable materials.

Vehicle 102 may include a roof 114. The roof 114 can form an upper portion of the vehicle 102. For example, at least a portion of the roof 114 can be positioned above at least a portion of the cabin 108. The roof 114 can optionally form an uppermost portion of the vehicle 102. The roof 114 can include and/or support a roof system 190, which can include a window, a panel, and the like. For example, the roof system 190 can include features to allow light and/or air to enter and/or exit the cabin 108. By further example, the roof system 190 can include an adjustable sunroof (e.g., pop-up, spoiler, inbuilt, folding, sliding, etc.), a panoramic roof system, one or more removable roof panels, a moonroof, and the like. In some embodiments, the roof system 190 can be adjustable to transition to different configurations (e.g., open and closed). In some embodiments, the roof system 190 can be fixed in a single configuration (e.g., moonroof, panoramic roof system, etc.). In some embodiments, the roof system 190 can include a material (e.g., glass, plexiglass, etc.) that is at least partially transparent (e.g., clear, tinted, etc.).

FIG. 1B is a diagram illustrating another example implementation of the vehicle 102. Vehicle 102 in this example may have a rear portion 106 with a rear cargo space (trunk) 119, e.g., behind a row of occupant seating, that may be internal to the rear portion 106. Rear cargo space 119 may be referred to as a trunk or as a cargo bed or rear cargo space. FIGS. 1A and 1B, respectively, depict example implementations of the vehicle 102 as a truck and a sport utility vehicle. However, these example implementations are merely illustrative, and the vehicle 102 may be implemented as any type of vehicle or other moveable apparatus (e.g., including, but not limited to, a van, a delivery van, a semi-truck, an aircraft, a watercraft, or the like).

As with the vehicle 102 of FIG. 1A, the vehicle 102 of FIG. 1B may include a roof 114 and/or a roof system 190. The roof 114 and/or the roof system 190 of the vehicle of FIG. 1B can include one or more features described herein with respect to the vehicle 102 of FIG. 1A. While only one roof system 190 is illustrated in each of FIGS. 1A and 1B, it will be understood that multiple roof systems 190 can be provided at the roof 114 with the same or different features with respect to each other.

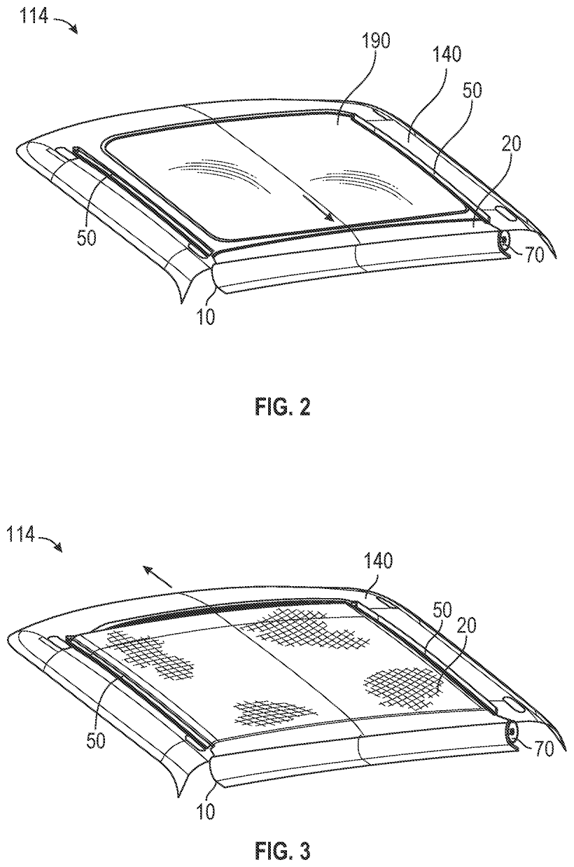

Referring now to FIGS. 2 and 3, a roof system of a vehicle can be included with a roller blind systems that selectively exposes or covers the roof system. As shown in FIG. 2, a roof 114 of a vehicle can include a roof system 190, which can be or include a window, sunroof, moonroof, and/or other structure. The roof system 190 can be supported by a body 140 of the vehicle. For example, the body 140 can surround at least a portion of the roof system 190, while allowing the roof system 190 to define a boundary between a cabin of the vehicle and an external environment. As further shown in FIG. 2, the roof system 190 can further include one or more portions that extend above at least a portion of the body 140. For example, a window and/or panel of the roof system 190 can be recessed to extend upwardly away from the cabin. Accordingly, the roof system 190 can form a concave shape on a side facing the cabin, such that space (e.g., headroom) within the cabin is maximized.

A roller blind system 10 can be provided in a vicinity of the roof system 190. As shown in FIG. 2, the roller blind system 10 can include a shade 20, which can be retracted into a coiled configuration about a roller drum 70. While the shade 20 is in the coiled configuration, the shade 20 can be retracted away from the roof system 190, such that at least a portion of the roof system 190 is exposed to the cabin of the vehicle underneath the roof 114. For example, the roller drum 70 can be positioned on a side (e.g., a rear side) of the roof system 190, so that the shade 20 can be retracted away from the roof system 190. The roller blind system 10 can include one or more rails 50 extending along sides (e.g., left and right sides) of the roof system 190. An end of each of the rails 50 can face the roller drum 70 to receive a portion of the shade 20.

As shown in FIG. 3, the roller blind system 10 can be operated to transition the shade 20 to a deployed configuration. For example, the shade 20 can extend from the roller drum 70 and/or along one or more rails 50. While the shade 20 is in the deployed configuration, the shade 20 can cover at least a portion of the roof system 190. For example, the shade 20 and the deployed configuration can be disposed between the roof system 190 and the cabin of the vehicle. As such, the shade 20 can block the cabin from light and/or air at the roof system 190.

While the shade 20 is in the deployed configuration, portions of the shade 20 can contact and/or engage portions of the roof system 190. For example, the rails 50 can urge portions of the shade 20 upwards against a surface of the roof system 190 that faces the cabin. Where the roof system 190 defines a concave or otherwise curved surface, portions of the shade 20 can conform to the shape of the roof system 190. For example, when deployed from the roller drum 70 and extending along the rails 50, portions of the shade 20 can be directed upwardly toward an against the roof system 190. Accordingly, the shade 20 can form a concave shape on a side facing the cabin, such that space (e.g., headroom) within the cabin is maximized. While the shade 20 can form a concave shape in the deployed configuration, portions of the shade 20 can transition to a flattened shape before being retracted into the coiled configuration about the roller drum 70, as described further herein. Such transitions can be fully reversible and repeatable as the shade transitions between the deployed configuration and the coiled configuration.

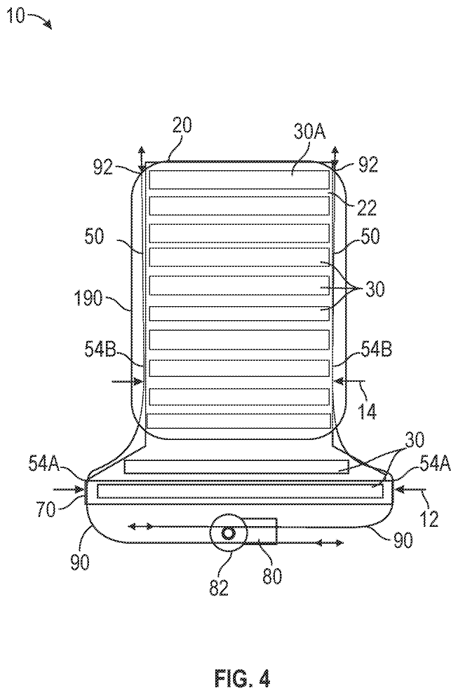

Referring now to FIG. 4, the shade of the roller blind system can transition between the deployed configuration and the coiled configuration to enhance space efficiency in both configurations. As shown in FIG. 4, the shade 20 of the roller blind system 10 can include a flexible sheet 22, and multiple bow springs 30 distributed along a length of the flexible sheet 22. As used herein, the length of the shade 20 and/or components thereof is generally measured along an axis that defines the extension and retraction of the shade 20 between the deployed configuration and the coiled configuration. Each of the bow springs 30 can define a width extending transversely with respect to the length of the flexible sheet 22. As used herein, a width of the shade 20 and/or components thereof is generally measured along an axis that is within a plane of the shade 20 and transverse (e.g., orthogonal) to the length. For example, an axis defining a width can extend through each of the rails 50 on opposing sides of the shade 20. As used herein, a height or thickness of the shade 20 and/or components thereof is generally measured along an axis that is transverse (e.g., orthogonal) to the length and width. For example, an axis defining a height or thickness can extend through the shade 20 in the deployed configuration and the roof system 190.

The roller blind system 10 can include a drive unit 80 operable to move a drive cable 90 coupled to the shade 20 and extending through a portion of the rails 50. As shown in FIG. 4, the roller blind system 10 can include a pair of drive cables 90 that are each coupled to the drive unit 80 as well as the shade 20. The drive unit 80 can include a drive gear 82 that is operable to move each of the drive cables 90. For example, the drive gear 82 can include one or more teeth that engages corresponding portions of the drive cables 90 (e.g., as with a rack and pinion mechanism). By further example, as the drive gear 82 of the drive unit 80 rotates, each of the drive cables 90 can be moved in unison to extend or retract the shade 20. It will be understood that a variety of mechanisms can be used to control movement of the drive cables 90, such as motors, actuators, gears, couplings, pneumatic actuators, hydraulic actuators, and the like.

In some embodiments, each of the drive cables 90 has a cable end 92 or other portion that is coupled to an endmost one 30A of the bow springs 30. For example, each of the drive cables 90 can be coupled to opposing sides of the endmost one 30A of the bow springs 30. As the drive cables 90 are extended, the shade 20 (e.g., flexible sheet and bow springs), is likewise extended. For example, the drive cables 90 can move the endmost one 30A of the bow springs 30, which will pull the flexible sheet 22 and the other bow springs 30 for extension thereof away from the roller drum 70. As the drive cables 90 are retracted, the shade 20 (e.g., flexible sheet and bow springs), is likewise retracted, as described further herein.

The roller blind system 10 can include a rail assembly configured to received opposing edges of the shade 20. The rail assembly can include a pair of rails 50 on opposing sides of the roof system 190. The rails 50 can each form different sections to guide and direct the shade 20 as it transitions. For example, each rail 50 can include a first channel section 54A and a second channel section 54B. The first channel sections 54A can be between the second channel sections 54B and the roller drum 70. The first channel sections 54A can receive the shade 20 as it extends from the roller drum 70 and guide the shade 20 to the second channel sections 54B. The first channel sections 54A can define a first width 12, and the second channel sections 54B can define a second width 14. The rails 50 transition from the first width 12, at the roller drum 70 and the first channel sections 54A, to the second width 14, at the second channel sections 54B.

The shade 20 is configured to transition between the deployed configuration and the coiled configuration. In the coiled configuration at the roller drum 70 and at the first channel sections 54A of the rails 50, opposing edges of the shade 20, defining the width 12 of the shade 20, are a first distance apart from each other, and the bow springs 30 are in a straight configuration. For example, the bow springs 30 extend laterally in a substantially flat or straight configuration to define the width 12. This allows the shade 20 to occupy less space while in the coiled configuration about the roller drum 70. In particular, the shade 20 has a smaller diameter in the coiled configuration than would be possible if the bow springs where curved (e.g., not substantially flat), as in the deployed configuration.

In the deployed configuration along the second channel sections 54B of the rails 50 and overlapping the roof system 190, the opposing edges of the shade 20, defining the width 14 of the shade 20, are a second distance, less than the first distance defined by the width 12, apart from each other. For example, the ends of each bow spring 30 are urged towards each other by the rails 50 to form a substantially curved configuration that defines the width 12. The curvature of the bow springs 30 in the deployed configuration results in greater height (e.g., thickness) of the shade 20 by extending upwardly towards and/or against the roof system 190. This allows the shade 20 to provide more headroom within the cabin of the vehicle than would be available if the bow springs 30 were substantially flat, as in the coiled configuration about the roller drum 70.

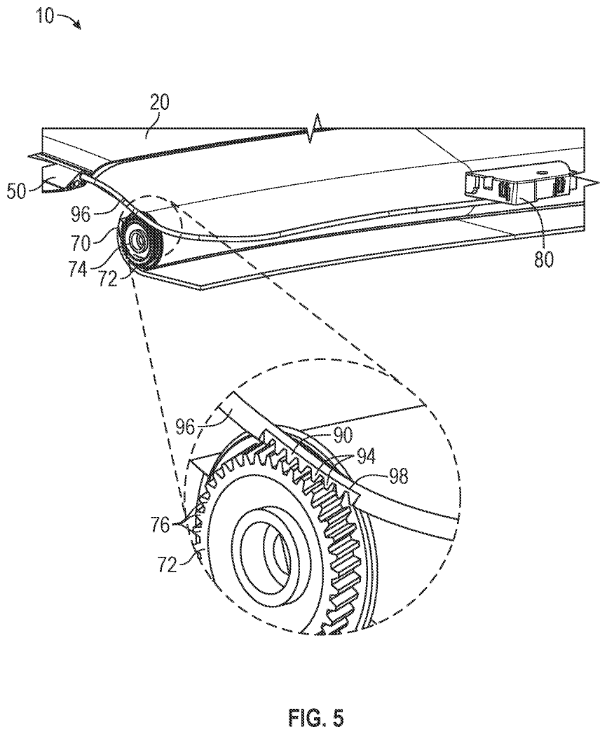

Referring now to FIG. 5, the drive unit can synchronize movement between the shade and the roller drum. As shown in FIG. 5, the roller blind system 10 can include a drive unit 80 operable to move a drive cable 90 coupled to the shade 20 and extending through a portion of the rails 50. In some embodiments, the roller blind system 10 can include one or more tubes 96 through which the drive cables 90 can travel. Additionally or alternatively, the drive cables 90 can be supported by brackets, a portion of the rails 50, and/or other supporting structures that facilitate travel of the drive cables 90 and engagement with the roller drum 70. The tubes 96 and/or other structure can guide the drive cables 90 as forces are applied thereto by the drive unit 80. In some embodiments, the roller drum 70 can include a roller gear 72 that engages corresponding portions of the drive cables 90. The tubes 96 can form an opening 98 through which a portion of the drive cables 90 can be exposed to the roller gear 72. As the drive unit 80 operates to move each of the drive cables 90, the drive cables 90 can simultaneously urge the shade 20 directly (e.g., via a coupling to a bow spring) and engage the roller gear 72 of the roller drum 70. For example, the roller gear 72 can include one or more teeth 76 that engage corresponding teeth 94 of the drive cables 90 (e.g., as with a rack and pinion mechanism). By further example, as the roller gear 72 of the roller drum 70 rotates, the roller drum 70 can rotate to facilitate extension or retraction of the shade 20. By further example, during retraction, the drive cables 90 can rotate the roller drum 70, which will pull the shade 20 for coiling about the roller drum 70.

Additionally or alternatively, one or more other mechanisms can facilitate extension or retraction of the shade 20 and/or rotation of the roller drum 70. For example, the roller drum 70 can include a spring 74 that applies a torque to the roller drum 70. Such a spring 74 can bias the roller drum to rotate to urge the shade 20 to the deployed configuration and/or the coiled configuration. For example, the rails 50 and/or another structure can include another spring (not shown) that applies a force to the shade 20. Such a spring can bias the shade 20 to the deployed configuration and/or the coiled configuration. The action of the drive unit 80 and/or the drive cables 90 can overcome such biasing forces.

While the drive cable 90 in FIG. 5 is shown as exposed, it will be understood that supporting structure, such as extensions of the illustrated rails and/other structures, can be provide to guide the drive cables 90. In particular, the first channel sections of the rails 50 are omitted from the illustrated region of FIG. 5 between the roller drum 70 and the illustrated rail 50. In some embodiments, additional channels can surround portions of the drive cables 90, such that a compression force from the drive unit 80 pushing the drive cables 90 can result in advancement thereof along a predetermined pathway. The drive cables 90 can have structure that supports both advancement by pushing and retraction by pulling.

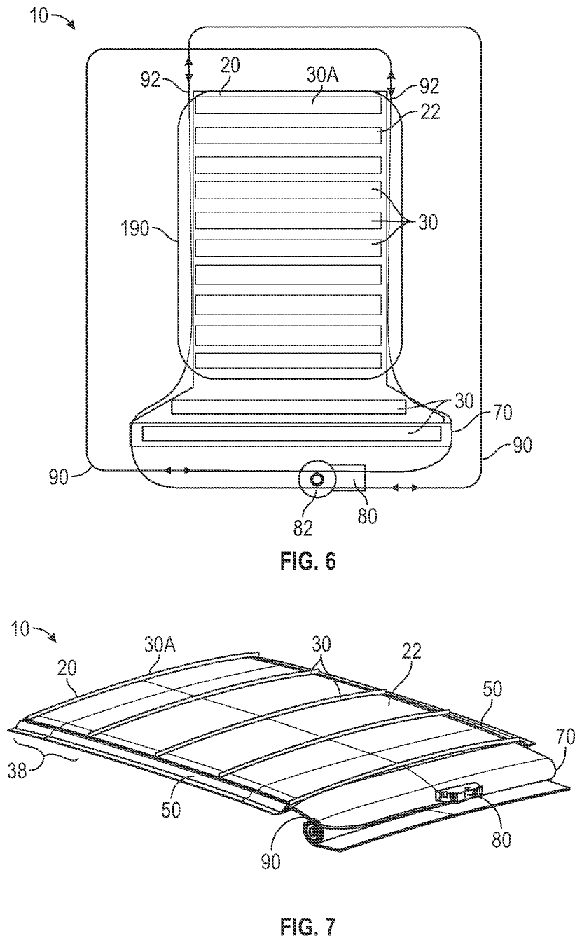

Referring now to FIG. 6, the drive unit can support stable movement of the shade. As shown in FIG. 6, the roller blind system 10 can include a pair of drive cables 90 that are each coupled to the drive unit 80 as well as the shade 20. In some embodiments, each of the drive cables 90 can form a closed loop. As in the embodiment of FIG. 4, each of the drive cables 90 has a cable end 92 or other portion that is coupled to an endmost one 30A of the bow springs 30. The drive unit 80 can apply a force that both pushes and pulls each drive cable 90 based on the closed loop arrangement. Accordingly, slack in the drive cables 90 can be managed to achieve synchronized movement of the shade 20 from both sides thereof.

Referring now to FIG. 7, the shade of a roller blind system can facilitate transition to a curved shape in a deployed configuration. As shown in FIG. 7, the shade 20 can include multiple bow springs 30 distributed along a length of the flexible sheet 22. Each of the bow springs 30 can extend transversely to the length of the flexible sheet 22. A curvature of the bow springs 30 can urge the flexible sheet 22 upwardly to conform to a roof system (not shown). The distribution of the bow springs 30 along the length of the flexible sheet 22 can provide flexibility and space efficiency. For example, each of the bow springs 30 can be separated from an adjacent one or pair of other bow springs 30 by a longitudinal gap 38. The distance is defining each longitudinal gap 38 can be the same or different between corresponding pairs of bow springs 30. The longitudinal gap 38 can be selected to support adequate shape definition of the flexible sheet 22, while also providing efficient packing of the shade 20 while in the coiled configuration. For example, as the shade 20 is retracted into the coiled configuration about the roller drum 70, each of the bow springs 30 can transition to a flat or straight configuration and nest between other pairs of bow springs 30, such as within a longitudinal gap 38 there between. Accordingly, although the bow springs 30 provide additional thickness of the shade 20, the shade 20 can be packed in a space efficient manner while in the coiled configuration.

In some embodiments, the bow springs 30 can abut the roof system, such that the longitudinal gap 38 between bow springs also creates an air gap between the flexible sheet 22 and the overlying roof system. Such an air gap can provide insulation between the external environment and the cabin.

In some embodiments, the bow springs 30 can include a strip on an uppermost portion thereof to contact the roof system. As the shade 20 transitions between the deployed configuration and the coiled configuration, the strips can wipe the exposed surface of the roof system to provide cleaning thereof.

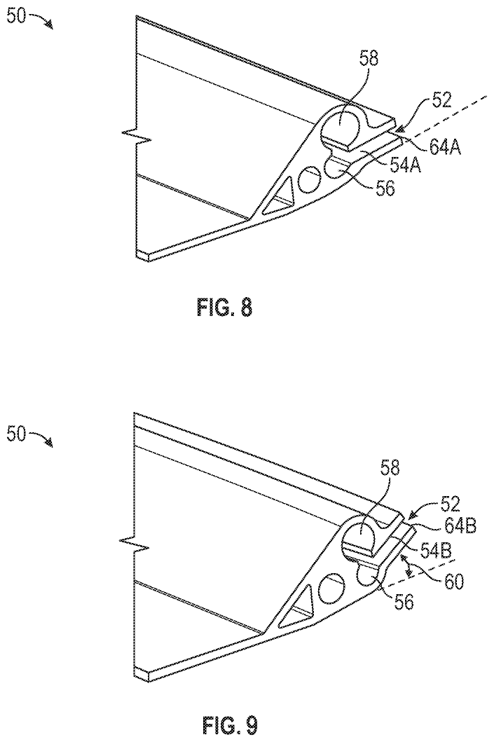

Referring now to FIGS. 8-11, rails of a roller blind system can facilitate transition of a shade between a deployed configuration and a coiled configuration.

As shown in FIG. 8, a rail 50 can include a channel 52 that extends along a length of the rail 50. The channel 52 can have an opening that extends along an inner edge of the rail 50. For example, the openings of each channel 52 can define an innermost portion of the channel 52 at an innermost side of the corresponding rail 50.

As further shown in FIGS. 8 and 9, each channel 52 can define a first channel section 54A (FIG. 8) and a second channel section 54B (FIG. 9). As described further herein, the first channel section 54A and the second channel section 54B can be joined together with transitions there between to form a continuous channel 52 that extends along the length of the corresponding rail 50. The channel 52 can further include a guide section 56 and a drive section 58.

While only one rail 50 is shown in each of FIGS. 8 and 9, it will be understood that each pair of rails can be provided opposite each other, as described herein. In some embodiments, the rails 50 can be symmetrical across a longitudinal axis of the roller blind system.

As shown in FIG. 8, the first openings 64A of channels 52 at the first channel sections 54A (e.g., on opposing sides of the roof system) can face each other, such that they are directed towards each other. For example, in some embodiments, each of the first openings 64A of channels 52 at the first channel sections 54A can be within a plane that extends through both of the rails 50, the channels 52, and the first channel sections 54A.

As shown in FIG. 9, the second openings 64B of channels 52 at the second channel sections 54B (e.g., on opposing sides of the roof system) can face somewhat upwardly, such that each is directed towards a region above the other. For example, in some embodiments, each of the second openings 64B of channels 52 at the second channel sections 54B can extend transverse to each other. By further example, the second openings 64B of channels 52 at the second channel sections 54B can form an angle 60 with respect to the direction of the first openings 64A of channels 52 at the first channel sections 54A.

In some embodiments, each of the channels 52 defines a guide section 56. The guide section 56 can be continuous with the first channel section 54A and the second channel section 54B, such that each section is part of a continuous whole that forms the channel 52. The guide section 56 can have a cross-sectional dimension that is greater than a cross-sectional dimensions of the first opening 64A of the first channel sections 54A and the second opening 64B of the second channel section 54B.

In some embodiments, each of the channels 52 defines a drive section 58. The drive section 58 can be continuous with the first channel section 54A and the second channel section 54B, such that each section is part of a continuous whole that forms the channel 52. As such, each of the channels 52 can form multiple sections that are continuous with each other. The cross-sectional shape and/or dimensions of each channel and its constituent sections can optionally be constant within a corresponding channel section. The channel sections can be continuous with each other, with transitions between each that change in cross-sectional shape and/or dimension.

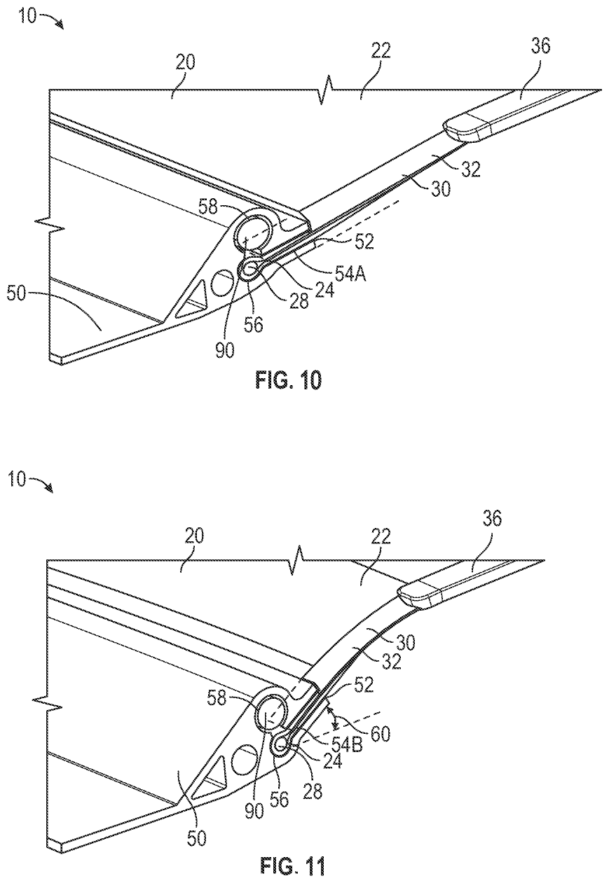

As shown in FIGS. 10 and 11, each of the rails 50 can receive a corresponding one of opposing edges 24 of the shade 20 in a channel 52 thereof. Each edge 24 of the shade 20 can include and/or be coupled to a guide cable 28. In some embodiments, the guide cable 28 can extend within a portion of the flexible sheet 22 of the shade. For example, the flexible sheet 22 can extend about a portion of the guide cable 28 and fold onto itself. Additional or alternative coupling mechanisms can be provided, such as adhesive, stitching, interweaving, fasteners, and the like. The guide cable 28 can reside within the guide section 56 of the channel 52. As the guide section 56 can have a larger cross-sectional dimension than other sections of the channel 52, the guide cable 28 and/or adjacent portions of shade 20 (e.g., the flexible sheet 22) can move longitudinally within the guide section 56 of the channel 52 without displacing to other sections of the channel 52. For example, the cross-sectional dimension of the guide cable 28 can be larger than the cross-sectional dimension of the openings of the channel 52. The guide cable 28 can extend across multiple bow springs 30 and/or some or all of the flexible sheet 22. While only one guide cable 28 is illustrated, it will be understood that the shade 20 can include a pair or more of guide cables 28, for example on opposing edges 24 of the shade 20 and residing within opposing rails 50 of the roller blind system 10.

In some embodiments, one or more of the bow springs 30 of the shade 20 can include a beam 32. The beam 32 can be somewhat resilient to facilitate bending while providing a bias to a present configuration. For example, the beams 32 can be metal, rubber, plastic, or another resilient material. By further example, the beams 32 can be biased to a flat shape with the bow spring 30 having its greatest width, as shown in FIG. 10. This can facilitate compact packing when the shade 20 is in the coiled configuration. The beam 32 can be coupled to the flexible sheet 22, for example with the flexible sheet 22 extending about ends of the beam 32 with a pocket formed therein. Additional or alternative coupling mechanisms can be provided, such as adhesive, stitching, interweaving, fasteners, and the like. At least the ends of the beams 32 can reside within the channels 52 of the rails.

The flexible sheet 22 of the shade 20 can facilitate transitions between the coiled configuration and the deployed configuration. In some embodiments, the flexible sheet 22 includes a cloth material. In some embodiments, the flexible sheet 22 includes one or more materials that are woven, knit, molded, and the like. The flexible sheet 22 can at least partially block transmission of light and/or air there through.

One or more of the bow springs 30 of the shade 20 can further include one or more pads 36. The pads 36 can be positioned on a side of the beam 32 that is opposite the flexible sheet 22. While the shade 20 is in the deployed configuration, the pads 36 define a maximum height of the shade 20. The pads 36 can provide a surface for contacting the roof system when the shade 20 is urged upwardly against the roof system. For example, the pads 36 can contact and slide against the roof system when the shade 20 transitions between the coiled configuration and the deployed configuration. The pads 36 can include a fabric or other materials that provides a soft surface. As the pads 36 slide against the roof system, the pads 36 can wipe debris, material, fluids, and the like off of the roof system.

Drive cables 90 can be provided at each of opposing sides of the shade 20. As described herein, the drive cables 90 can be couples to the endmost one of the bow springs 30. Other bow springs 30 need not be directly coupled to the drive cables 90, so that portions of the shade can freely coil about the drum roll while separating from the drive cables 90. The drive cable 90 can reside within the drive section 58 of the channel 52. The drive cable 90 can move longitudinally within the drive section 58 of the channel 52. While only one drive cable 90 is illustrated, it will be understood that the shade 20 can include and/or be coupled to a pair or more of drive cables 90, for example on opposing sides of the endmost one of the bow springs 30. Portions of the drive cables 90 and the guide cables 28 can extend in parallel with each other within the corresponding portions of the channel 52.

As shown in FIG. 10, the first openings 64A of channels 52 at the first channel sections 54A (e.g., on opposing sides of the roof system) can face each other, such that they are directed towards each other and receive the shade 20 in a flat configuration. For example, in some embodiments, each of the first openings 64A of channels 52 at the first channel sections 54A can be within a plane that extends through both of the rails 50, the channels 52, and the first channel sections 54A. This orientation, along with the greater distance between opposing first channel sections 54A, can allow the shade 20 to extend to a greater width and be flat near the roller drum about which it can be coiled when retracted.

As shown in FIG. 11, the second openings 64B of channels 52 at the second channel sections 54B (e.g., on opposing sides of the roof system) can face somewhat upwardly, such that each is directed towards a region above the other to urge the shade 20 in a curved configuration. For example, in some embodiments, each of the second openings 64B of channels 52 at the second channel sections 54B can extend transverse to each other. For example, the second openings 64B of channels 52 at the second channel sections 54B can form an angle 60 with respect to the direction of the first openings 64A of channels 52 at the first channel sections 54A and/or a plane of the shade 20 in a flat configuration adjacent to the roller drum. Such a non-zero angle 60 can correspond to the upward direction of the shade 20 when placed in the channel 52. The angle 60 can correspond to a direction of extension of the roof system near the rails 50. This orientation, along with the lesser distance between opposing second channel sections 54B, can allow the shade 20 to bow upwardly (e.g., against the roof system) when in the deployed configuration.

Accordingly, the shade 20 of the roller blind system 10 be operated to controllably cover or expose portions of the roof system so that the passengers of the vehicle can determine whether to receive the effects of the light and/or air as desired. The shade 20 (e.g., cloth) of the roller blind system 10 can be retracted into a coil with bow springs 30 fully extended in a straight configuration at their maximum width. This can allow the shade 20 to be stored in a highly compact configuration. When deployed, the ends of the bow springs 30 are urged towards each other to form a narrower width and a curved shape. This can allow the shade 20 to conform to the curved shape of the overlying roof system (e.g., glass) and provide more headroom within the cabin than would be provided with a flat shade.

In some embodiments, the shape, thickness, and material properties of the flexible sheet 22 may be configured to have a curvature similar to that of the bow springs 30 when in the deployed configuration, resulting in greater height (e.g., thickness) of the shade 20 by extending upwardly towards and/or against the roof system 190. For example, in such embodiments, flexible sheet 22 may be formed of somewhat resilient material to facilitate bending with ends of the flexible sheet residing within the channels 52 of the rails, similar to the beams 32 described with reference to FIG. 11. In such embodiments, the flexible sheet 22 may hold its curvature in the deployed configuration while a single bow spring 30 (e.g., an endmost one 30A of the bow springs 30) may be used to pull the flexible sheet 22 and the other bow springs 30 for extension thereof away from the roller drum 70 into the deployed configuration.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A shade for a roller blind system, the shade comprising:
a flexible sheet;
one or more bow springs distributed along a length of the flexible sheet, each of the bow springs extending transversely to the length of the flexible sheet; and
multiple pads, each of the pads being positioned on a side of a corresponding one of the bow springs that is opposite the flexible sheet.

2. The shade of claim 1, further comprising guide cables each extending along one of opposing ends of the flexible sheet and adjacent to a corresponding end of each of the bow springs.

3. The shade of claim 1, wherein the shade is configured to transition between:
a coiled configuration about a roller drum with each of the bow springs in a straight configuration; and
a deployed configuration within a rail assembly with each of the bow springs in a curved configuration.

4. The shade of claim 3, wherein, in the deployed configuration, the multiple pads define a maximum height of the shade.

5. The shade of claim 3, wherein:
in the coiled configuration, opposing edges of the shade, defining a width of the shade, are a first distance apart from each other; and
in the deployed configuration, the opposing edges of the shade are a second distance, less than the first distance, apart from each other.

6. The shade of claim 5, further comprising guide cables each coupled to a corresponding one of the opposing edges of the shade.

7. The shade of claim 6, further comprising drive cables coupled to opposing sides of an endmost one of the bow springs, portions of the drive cables extending in parallel with portions of the guide cables.

8. The shade of claim 1, wherein the flexible sheet comprises a cloth material.

9. The shade of claim 1, wherein each of the multiple pads comprises a fabric material.

10. A rail assembly for a roller blind system, the rail assembly comprising:
a pair of rails each configured to receive a corresponding one of opposing edges of a shade, each of the rails defining a channel having a first channel section and a second channel section,
wherein the first channel sections are separated from each other by a first distance and define first openings directed towards each other, and
wherein the second channel sections are separated from each other by a second distance, less than the first distance, and define second openings each directed above the other of the second channel sections.

11. The rail assembly of claim 10, wherein the first channel sections extend in parallel with each other, and the second channel sections are transverse to each other.

12. The rail assembly of claim 10, wherein each of the channels defines a guide section continuous with the first channel section and the second channel section, the guide section having a cross-sectional dimension that is greater than cross-sectional dimensions of the first openings and the second openings.

13. The rail assembly of claim 10, wherein each of the channels defines a drive section for receiving a drive cable, the drive section being continuous with the first channel section and the second channel section of the corresponding channel.

14. The rail assembly of claim 10, wherein the rails define a first width at the first channel sections and a second width at the second channel sections, the second width being smaller than the first width.

15. A roller blind system comprising:
a shade comprising a flexible sheet and one or more bow springs;
a roller drum; and
a rail assembly configured to receive opposing edges of the shade,
wherein the shade is configured to transition between:
a coiled configuration about the roller drum with each of the bow springs in a straight configuration; and
a deployed configuration within the rail assembly with each of the bow springs in a curved configuration.

16. The roller blind system of claim 15, wherein:
in the coiled configuration, the opposing edges of the shade are a first distance apart from each other; and
in the deployed configuration, the opposing edges of the shade are a second distance, less than the first distance, apart from each other.

17. The roller blind system of claim 15, further comprising a drive unit configured to move drive cables coupled to the shade and extending through corresponding channels of the rail assembly.

18. The roller blind system of claim 17, wherein the drive cables are further coupled to gears of the roller drum, wherein movement of the drive cables is configured to rotate the roller drum.

19. The roller blind system of claim 17, wherein the drive cables are coupled to opposing sides of an endmost one of the bow springs of the shade.

20. The roller blind system of claim 17, wherein each of the drive cables forms a closed loop.
